(19) United States
(12) Patent Application Publication
(10) Pub. No.: US 2024/0082771 A1
(43) Pub. Date: Mar. 14, 2024

(54) REDUCED-SIZE DEVICE FOR AIR PURIFICATION

(71) Applicant: AIRINSPACE, ELANCOURT (FR)

(72) Inventors: Nicolas KLACZYNSKI, Jouars Ponchartrain (FR); Stephen LUNEL, Angervilliers (FR)

(21) Appl. No.: 18/263,053

(22) PCT Filed: Feb. 4, 2022
(86) PCT No.: PCT/EP2022/052715

§ 371 Date: Jul. 26, 2023

(30) Foreign Application Priority Data
Feb. 4, 2021 (FR) 2101083

(51) Int. Cl. B01D 46/12; B01D 46/00; B01D 46/62; F24F 8/108; F24F 13/28

(52) U.S. Cl. CPC B01D 46/12; B01D 46/001; B01D 46/62; F24F 8/108; F24F 13/28; B01D 2267/30; B01D 2267/40; B01D 2275/40

(57) ABSTRACT

Disclosed is a device for air purification, including: a base that may or may not be in direct contact with the surface on which it is placed, which base preferably has a rectangular contour; at least four side walls each including a filter, which side walls are preferably perpendicular to the base; an upper wall, on the face opposite its base including a prefilter-type filter formed of a flexible, foam or even fabric, honeycomb material; a source of electrical power; an air pressurizer connecting to the power source and ensuring the flow of air through the device; a duct between the filter on the upper wall and the air pressurizer. The pressurizer ensure air is sucked through the filter on the upper wall towards the air pressurizer, then flows from the pressurising to each filter in each side wall, before its discharge to the exterior of the device.

The present patent application claims the priority of the French patent application FR 2101083 filed on Feb. 4, 2021.

### TECHNICAL FIELD

The present invention belongs to the field of air purification and relates to a reduced-size device for air purification, a method for air filtration, as well as the use of such a device for air filtration.

It is known from the prior art that small air filtration devices, in the form of a parallelepiped, suck in the surrounding air through their 4 lateral faces and discharge it through the upper face. Such devices corresponding to the conventional architecture are described, including U.S. Pat. No. 6,174,340 B1 and U.S. Pat. No. 5,266,090. We also know much larger devices which suck in air through their upper face and evacuate it through their 4 lateral faces and whose internal volume allows good functioning.

### SUMMARY OF THE INVENTION

The inventors have now developed an air filtration device which, when placed on the floor and despite its small dimensions, nonetheless provides very good air filtration of a volume greater than 50 m³.

This very good efficiency is due to a particular architecture in which the air is sucked in through the upper part and discharged through the 4 lateral sides of the device, which is the opposite of what has been achieved until now for devices of this size. Besides the fact that this architecture allows a considerable flow rate, it has been demonstrated that the aeraulic profile of this solution is very good, with filtration efficiency that is as good as it is unexpected. The said aeraulic profile thus allows quiet functioning of the device according to the invention, which is very advantageous for the user.

Consequently, a first object of the invention relates to a device (1) for air purification comprising:
at least one base (2) which may comprise skids, feet or end pieces enabling it not to be in direct contact with the surface on which it is placed, which base (2) preferably has a rectangular outline,
at least four side walls (3) each comprising at least one filter (4), which side walls are preferably perpendicular to the base (2),
at least one upper wall (5), on the side opposite its base (at its top), comprising at least one pre-filter type filter (6) made of a flexible foam-like material or a fabric.,
at least one duct (8) between the at least one pre-filter type filter (6) located on the upper wall (5) and the air overpressurization means (7),
at least one electrical power source,
at least one air overpressurization means (7), connected to the power source and enabling the air (A) to flow through the device (1),

characterised in that:
the device has a height between 250 mm and 900 mm, a width between 200 mm and 700 mm and a depth between 300 mm and 600 mm;
the surface of the upper wall (5) is openwork for at least 70% of the total surface of this upper wall (5);
the surface of each of the four side walls (3) is openwork for at least 70% of the total surface of this side wall (3); and
the overpressurization means (7) makes it possible to obtain an operating flow rate of between 400 and 3,000 m³/h and to ensure that the air is sucked in through the at least one pre-filter type filter (6) located on the upper wall (5) towards the air overpressurization means (7), and then flows from the overpressurization means (7) through each of the at least one filters (4) present in each of the four side walls before being discharged to the outside of the device.

In this way, the device according to the invention presents, despite its small dimensions, a very high degree of compactness. In this architecture, the arrangement of the terminal filters (4) also makes it possible to have a large filtration surface for a low pressure loss. Finally, the device (1) according to the invention is capable, despite its very small dimensions, of effectively purifying the air in a room while also being extremely discreet due to the silence of operation associated with its improved efficiency.

Advantageously, a device (1) according to the invention has:
une height of between 300 m and 800 mm,
une width of between 300 mm and 600 mm, and
une depth of between 400 and 500 mm.

A second object of the invention relates to a method for air filtration, characterised in that it comprises at least the following steps:
installation of a device (1) according to the invention in a room, then
starting up the air overpressurization means (7) connected to the power source.

A third object of the invention relates to the use of a device (1) according to the invention for filtering air.

### BRIEF DESCRIPTION OF THE FIGURES

FIG. 1 represents the operating mode of a device (1) according to the invention.

FIG. 2 is a side view of a device (1) according to the invention in operation.

FIG. 3 is a top view of a device (1) according to the invention in operation.

Other features, details and advantages of the invention will become clearer from the detailed description given below by way of illustration in relation to drawings in which:

### DETAILED DESCRIPTION OF THE INVENTION

According to a first aspect, the invention relates to a device (1) for air purification. Typically, the device according to the invention will take the shape of a prism, preferably a straight prism, of which the base (2) and the upper wall (5) are the bases. Typically, this prism may take the shape of a prism with a rectangular, pentagonal, hexagonal, heptagonal or octagonal base, for example.

Preferably, the device (1) according to the invention will take the shape of a prism with a rectangular base and, particularly preferably, a right prism with a rectangular base.

By “air purification”, we mean obtaining good quality ambient air. The good quality of the ambient air can be assessed on the basis of various parameters, for example the concentration of volatile organic compounds (VOCs), the concentration of fine particles, such as the concentration of fine particles with a diameter of less than 10 μm (PM 10) and/or the concentration of fine particles with a diameter of less than 2.5 μm (PM 2.5), etc.

In this case, “air purification” means obtaining air containing a lower concentration of fine particles.

The device (1) according to the invention is capable, despite its very small dimensions (maximum height: 900 mm, maximum width: 700 mm, maximum depth: 600 mm), of effectively purifying the air in a room while also being extremely discreet due to the silence of operation associated with its improved efficiency.

Advantageously, a device (1) according to the invention will have a height of between 300 mm and 800 mm, a width of between 300 mm and 600 mm, and a depth of between 400 mm and 500 mm.

The structural elements of a device (1) according to the invention, which are the base (2), the at least four side walls (3) and the upper wall (5), are made of metal, plastic or composite.

Advantageously, the surface of the upper wall (5) of the device (1) is openwork for at least 80% and preferably for at least 90% of the total surface of the upper wall (5).

With regard to the nature of this pre-filter type filter (6) and as a flexible foam-like material, we can mention polyether. The pre-filter type filter (6) allows the filtration of 90 to 100% of particles with a diameter greater than or equal to 5.0 μm.

Advantageously, the pre-filter type filter (6) may comprise activated carbon so as to be able to trap the volatile organic compounds (VOCs) present in the air.

As regards the four side walls (3), the surface of each of these four side walls (3) of the device (1) is advantageously openwork for at least 80% of the total surface of this side wall (3) and, in a particularly preferred manner, for at least 90% of the total surface of this side wall (3).

Regarding the nature of the filters (4) included within the side walls (3) of the device (1) according to the invention, they may consist of one or more porous, fibrous or granular materials or mixtures thereof. Preferably, the filters (4) are made of a fibrous material such as glass fibre and polytetrahydrofluoroethylene (PTFE), particularly preferably PTFE.

These filters (4) are such that they allow filtration of greater than or equal to 99.99% of particles with a diameter greater than or equal to 0.3 μm.

According to a particular embodiment, the filters (4) are high-efficiency HEPA-type air filters. By HEPA filter is meant a filter capable of filtering, in a single pass, at least 99.97% of particles with a diameter greater than or equal to 0.3 μm.

Now, each of these filters (4 and 5) may or may not be formed by superimposing several layers of the same material or of different materials. These filters (4 and 5) are of sufficient thickness to allow effective filtration of the air. Typically, the said filters (4 and 5) have a thickness equal to or greater than 3 mm, preferably equal to or greater than 5 mm and, even more preferably, equal to or greater than 8 mm. It should be noted that the surface of each of the filters (4 and 5) may be flat or have multiple folds (V) so as to increase the contact surface.

The air overpressurization means (7) may take the shape of a fan or a turbine, preferably a turbine.

Advantageously, the air overpressurization means (7) of a device (1) according to the invention makes it possible to obtain an operating flow rate of between 500 and 2,200 m³/h.

The electrical power source to which the air overpressurization means (7) is connected may take the shape of a connection to the domestic electrical network or a storage battery. Optionally, the electrical power source may be coupled to a transformer in order to deliver to the air overpressurization means (7) an electrical current having characteristics suitable for its correct operation.

According to a particular embodiment, at least one of the side walls (3) is movable and able to allow access to the inside of the device (1) according to the invention, preferably to allow access to the air overpressurization means (7).

Said at least one movable side wall (3) may or may not comprise at least one hinge connecting it to the device (1) according to the invention and capable of allowing it to pivot.

Advantageously, a device (1) according to the invention comprises a switch capable of controlling the power supply to the air overpressurization means (7). Alternatively, such a switch (30) can be controlled remotely, for example using a remote control.

Advantageously, a device (1) according to the invention comprises a programmer By programmer is meant a mechanical or electronic system, for example a central processing unit, capable of controlling the operation of the air overpressurization means (7), either to adjust its flow rate or to define operating time ranges.

According to a particular embodiment, a device (1) according to the invention may comprise at least one sensor capable of measuring the quality of the ambient air. Non-exhaustively, this at least one sensor may be a volatile organic compound (VOC) sensor, a fine particle sensor, for example a fine particle sensor with a diameter of less than 10 μm (PM 10) and/or a fine particle sensor with a diameter of less than 2.5 μm (PM 2.5).

According to a second aspect, the invention relates to a method for air filtration characterised in that it comprises at least the steps of:
installation of a device (1) according to the invention in a room, then
starting the air overpressurization means (7) connected to the power source.

Advantageously, the installation of a device (1) according to the invention in a room will not be against a wall of said room.

Still advantageously, a method for air filtration according to the invention can be effectively implemented in a room having a volume less than or equal to 100 m³, preferably less than or equal to 50 m³.

By efficient implementation of a method for air filtration according to the invention obtaining good quality ambient air in a given time.

In this case, by air filtration is meant a reduction in the concentration of fine particles in the room of at least 90%, preferably at least 95% and particularly preferably at least 99%.

It should be noted that such a reduction is observed after at least one hour of operation.

According to a final aspect, the invention relates to the use of a device (1) according to the invention for air filtration.

The following examples are provided by way of illustration and are not intended to limit the scope of the present invention.

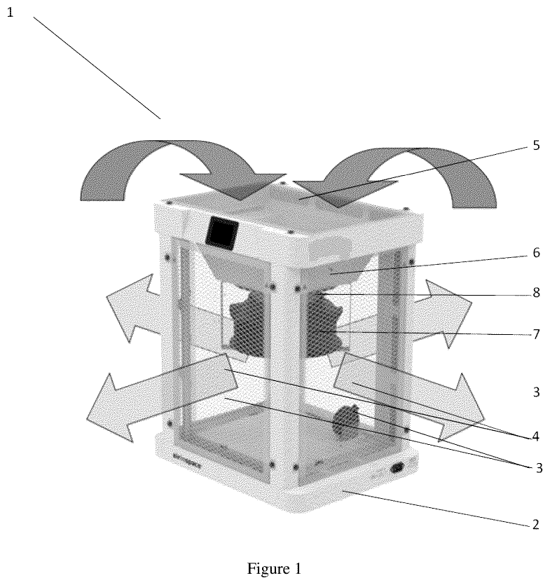

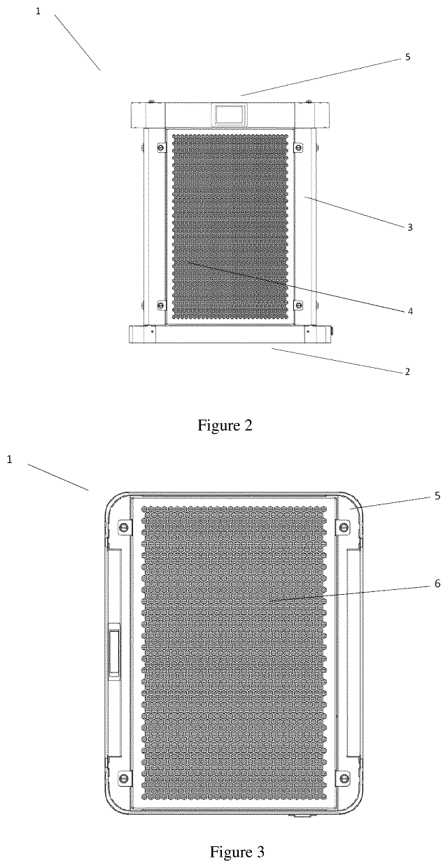

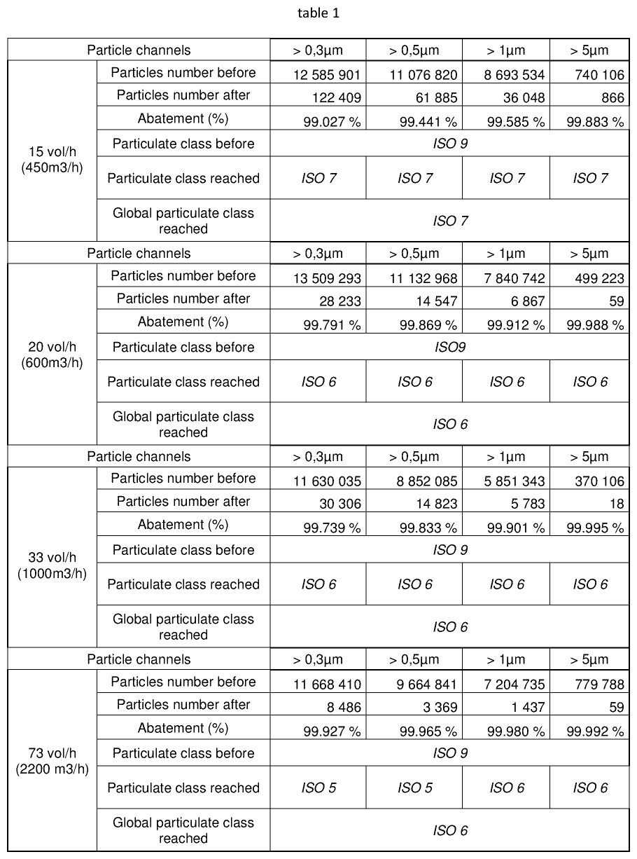

A device according to the invention has been assembled, which is shown in FIGS. 1, 2 and 3 wherein

The device was then installed in the centre of a 28 M3 room and the flow rate of the device was switched on with an overpressurization means set to a flow rate of 450, 600, 1,000 or 2,200 m³/h before measuring the particulate removal efficiency after 30 minutes. The values measured are described in Table 1.

The results show that, despite the very small size of the device according to the invention, it can achieve excellent particle removal in a short time because of its original architecture.

1. A device for air purification comprising:
at least one base which may comprise skids, feet or end pieces enabling it not to be in direct contact with the surface on which it is placed,
at least four side walls each comprising at least one filter,
at least one upper wall, on the side opposite to the base, comprising at least one pre-filter type filter made of a flexible foam-like material or a fabric,
at least one electrical power source,
at least one air overpressurization means connected to the power source and enabling the of air to flow through the device, wherein:
the device has a height of between 250 mm and 900 mm, a width of between 200 mm and 700 mm and a depth of between 300 mm and 600 mm;
the surface of the upper wall is openwork for at least 70% of the total surface of this upper wall;
the surface of each of the four side walls is openwork for at least 70% of the total surface of this side wall; and
the overpressurization means makes it possible to obtain an operating flow rate of between 400 and 3,000 m³/h and to ensure that the air is sucked through the at least one pre-filter type filter located on the upper wall towards the air overpressurization means, and then flows from the overpressurization means through each of the at least one filters present in each of the four side walls before being discharged to the outside of the device.

2. The device according to claim 1, wherein the device is prism-shaped.

3. The device according to claim 1, having a height of between 300 mm and 800 mm, a width of between 300 mm and 600 mm, and a depth of between 400 and 500 mm.

4. The device according to claim 1, wherein the surface of the upper wall of the device is openwork for at least 80% of the total surface of the upper wall.

5. The device according to claim 1, wherein the pre-filter type filter consists of a flexible foam-like material.

6. The device according to claim 1, wherein the surface of each of these four side walls of the device is openwork for at least 80% of the total surface of this side wall.

7. The device according to claim 1, wherein the filters included within the side walls of the device consist of one or more porous, fibrous or granular materials or mixtures thereof.

8. The device according to claim 1, wherein the air overpressurization means of a device according to the invention makes it possible to obtain an operating flow rate of between 500 and 2,200 m3/h.

9. A method for air filtration, comprising:
placing the device of claim 1 for filtering the air in a room, then
starting the air overpressurization means (7) connected to the power source.

10. (canceled)

11. The device of claim 1, wherein the base has a rectangular outline, and the side walls are perpendicular to the base.

12. The device of claim 7, wherein the filters comprise fibrous material.

13. The device according to claim 2, having a height of between 300 mm and 800 mm, a width of between 300 mm and 600 mm, and a depth of between 400 and 500 mm.

14. The device according to claim 2, wherein the surface of the upper wall of the device is openwork for at least 80% of the total surface of the upper wall.

15. The device according to claim 3, wherein the surface of the upper wall of the device is openwork for at least 80% of the total surface of the upper wall.

16. The device according to claim 2, wherein the pre-filter type filter consists of a flexible foam-like material.

17. The device according to claim 3, wherein the pre-filter type filter consists of a flexible foam-like material.

18. The device according to claim 4, wherein the pre-filter type filter consists of a flexible foam-like material.

19. The device according to claim 2, wherein the surface of each of these four side walls of the device is openwork for at least 80% of the total surface of this side wall.

20. The device according to claim 3, wherein the surface of each of these four side walls of the device is openwork for at least 80% of the total surface of this side wall.

21. The device according to claim 4, wherein the surface of each of these four side walls of the device is openwork for at least 80% of the total surface of this side wall.
